(19) United States
(12) Patent Application Publication
(10) Pub. No.: US 2006/0036876 A1
(43) Pub. Date: Feb. 16, 2006

(54) Key lock control method, electronic apparatus and computer-readable storage medium

(75) Inventor: Yasuyuki Kitada, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/987,341

(22) Filed: Nov. 15, 2004

(30) Foreign Application Priority Data
Aug. 10, 2004 (JP) 2004-233482

(51) Int. Cl. G06F 12/14; H04L 9/32; G06F 11/30

(52) U.S. Cl. 713/193

(57) ABSTRACT

A key lock control method registers an operation pattern of operation keys of an electronic apparatus which has a plurality of functions, and locks the operation keys if the operation keys are not operated according to the operation pattern. The operation pattern is made up of a combination of at least a time band in which one or more operation keys are to be operated and at least one function that is to be selected by one or more operation keys.

### BACKGROUND OF THE INVENTION

This application claims the benefit of a Japanese Patent Application No. 2004-233482 filed Aug. 10, 2004, in the Japanese Patent Office, the disclosure of which is hereby incorporated by reference.

1. Field of the Invention

The present invention generally relates to key lock control methods, electronic apparatuses and computer-readable storage media, and more particularly to a key lock control method for controlling locking of operation keys of an electronic apparatus, an electronic apparatus employing such a key lock control method, and a computer-readable storage medium which stores a program for causing a computer to carry out such a key lock control method.

In this specification, control keys of an electronic apparatus include switches, buttons, keys and the like that can be operated by a user when the user inputs information to the electronic apparatus. The structure of the operation key itself is not limited to a particular structure, and the operation key may take the form of a mechanical push-button or a key of a so-called touch panel.

2. Description of the Related Art

Operation keys are provided in electronic apparatuses such as computers and portable telephone sets. The operation keys can be operated by the user when the user inputs information to the electronic apparatus. For example, in the case of the portable telephone set, the operation keys are operated when inputting a telephone number and when selecting various functions. In addition, the portable telephone set is normally provided with a key lock function to lock the operation keys. The operation keys are locked by the key lock function in order to prevent an erroneous operation of the operation keys and to improve security by preventing unauthorized use of the mobile telephone set by a person other than the legitimate user.

Various methods have been proposed to lock the operation keys. According to a first method, once the key lock function is selected, the normal operation of the operation keys cannot be made until an operation is made to cancel the key lock function. According to a second method, it is possible to set a time band in which the operation keys are to be locked, and the operation keys can be operated in time bands other than the set time band without requiring an operation to cancel the key lock function. A third method is applied to a folding type portable telephone set, and the operation keys are locked automatically after a predetermined time elapses from a time when a lid of the portable telephone set is closed.

For example, a Japanese Laid-Open Patent Application No. 2001-285442 proposes the third method described above.

On the other hand, a Japanese Laid-Open Patent Application No. 2002-64620 proposes a fourth method which locks and unlocks the operation keys when a predetermined operation only known to the user is carried out.

However, according to the second and fourth methods, in a state where the operation keys are locked, the normal operation of the operation keys is not possible unless an operation is carried out to cancel the key lock function or to unlock the operation keys. For this reason, when the key lock function is selected to lock the operation keys, the operation to cancel the key lock function or to unlock the operation keys must be made every time the electronic apparatus is to be used, and there was a problem in that a complicated operation is required in order to use the electronic apparatus.

Similarly, according to the second method, in order to use the electronic apparatus in the set time band in which the operation keys are locked, an operation must be made to cancel the key lock function. In addition, every time the manner in which the electronic apparatus is used by the user changes, the user must newly set the time band in which the operation keys are to be locked, and there was a problem in that a complicated operation is required in order to use the electronic apparatus in a desired manner to suit the needs of the user.

According to the third method, the operation keys are locked automatically after the predetermined time elapses from the time when the lid of the electronic apparatus is closed. For this reason, an operation must be made to cancel the key lock function, similarly as in the case of the first method described above, every time the lid is opened to use the electronic apparatus. Moreover, there was a problem in that, even if the lid of the electronic apparatus is closed, an unauthorized use of the electronic apparatus by a person other than the legitimate user cannot be prevented until the predetermined time elapses from the time when the lid is closed.

### SUMMARY OF THE INVENTION

Accordingly, it is a general object of the present invention to provide a novel and useful key lock control method, electronic apparatus and computer-readable storage medium, in which the problems described above are suppressed.

Another and more specific object of the present invention is to provide a key lock control method, an electronic apparatus and a computer-readable storage medium, which lock operation keys of an electronic apparatus according to an operation pattern in order to improve security and to suppress unwanted locking of the operation keys.

Still another object of the present invention is to provide a key lock control method comprising registering an operation pattern of operation keys of an electronic apparatus which has a plurality of functions; and locking the operation keys if the operation keys are not operated according to the operation pattern, where the operation pattern comprises a combination of at least a time band in which one or more operation keys are to be operated and at least one function that is to be selected by one or more operation keys. According to the key lock control method of the present invention, it is possible to improve security and to suppress unwanted locking of the operation keys.

A further object of the present invention is to provide an electronic apparatus having a plurality of functions, comprising a plurality of operation keys; a memory part configured to register an operation pattern of the operation keys based on inputs from the operation keys; and a control part configured to lock the operation keys if the operation keys are not operated according to the operation pattern, where the operation pattern comprises a combination of at least a time band in which one or more operation keys are to be operated and at least one function that is to be selected by one or more operation keys. According to the electronic apparatus of the present invention, it is possible to improve security and to suppress unwanted locking of the operation keys.

Another object of the present invention is to provide a computer-readable storage medium which stores a program for causing a computer to lock operation keys of an apparatus having a plurality of functions, the program comprising a procedure causing the computer to register an operation pattern of the operation keys; and a procedure causing the computer to lock the operation keys if the operation keys are not operated according to the operation pattern, where the operation pattern comprises a combination of at least a time band in which one or more operation keys are to be operated and at least one function that is to be selected by one or more operation keys. According to the computer-readable storage medium of the present invention, it is possible to improve security and to suppress unwanted locking of the operation keys.

Still another object of the present invention is to provide a computer program for causing a computer to lock operation keys of an apparatus having a plurality of functions, comprising causing the computer to register an operation pattern of the operation keys; and causing the computer to lock the operation keys if the operation keys are not operated according to the operation pattern, where the operation pattern comprises a combination of at least a time band in which one or more operation keys are to be operated and at least one function that is to be selected by one or more operation keys. According to the computer program of the present invention, it is possible to improve security and to suppress unwanted locking of the operation keys.

Other objects and further features of the present invention will be apparent from the following detailed description when read in conjunction with the accompanying drawings.

### BRIEF DESCRIPTION OF THE DRAWINGS

FIG. 1 is a system block diagram showing a structure of an important part of an embodiment of an electronic apparatus according to the present invention;

FIG. 2 is a flow chart for explaining an operation pattern registration process of the embodiment;

FIG. 3 is a flow chart for explaining a part of the operation pattern registration process;

FIG. 4 is a flow chart for explaining a part of the operation pattern registration process;

FIG. 5 is a flow chart for explaining a part of the operation pattern registration process;

FIG. 6 is a flow chart for explaining a part of the operation pattern registration process;

FIG. 7 is a flow chart for explaining a part of the operation pattern registration process;

FIG. 8 is a flow chart for explaining a part of the operation pattern registration process;

FIG. 9 is a flow chart for explaining a key lock process of the embodiment; and

FIG. 10 is a diagram for explaining the key lock process of the embodiment.

### DESCRIPTION OF THE PREFERRED EMBODIMENTS

When using an electronic apparatus having a plurality of functions, a user in most cases selects predetermined functions within predetermined time bands. In other words, operation keys of the electronic apparatus are in most cases operated in predetermined operation patterns that are regular or systematic for each user. The operation pattern is a combination of at least a time band in which the operation keys are operated and at least one function that is selected by one or more operation keys.

Hence, in the present invention, the operation pattern of the user is registered in advance, and the operation keys are locked automatically when the operation keys are operated with an operation pattern other than the registered operation pattern, so as to improve security and to suppress unwanted locking of the operation keys.

A description will now be given of embodiments of a key lock control method, an electronic apparatus and a computer-readable storage medium according to the present invention, by referring to the drawings.

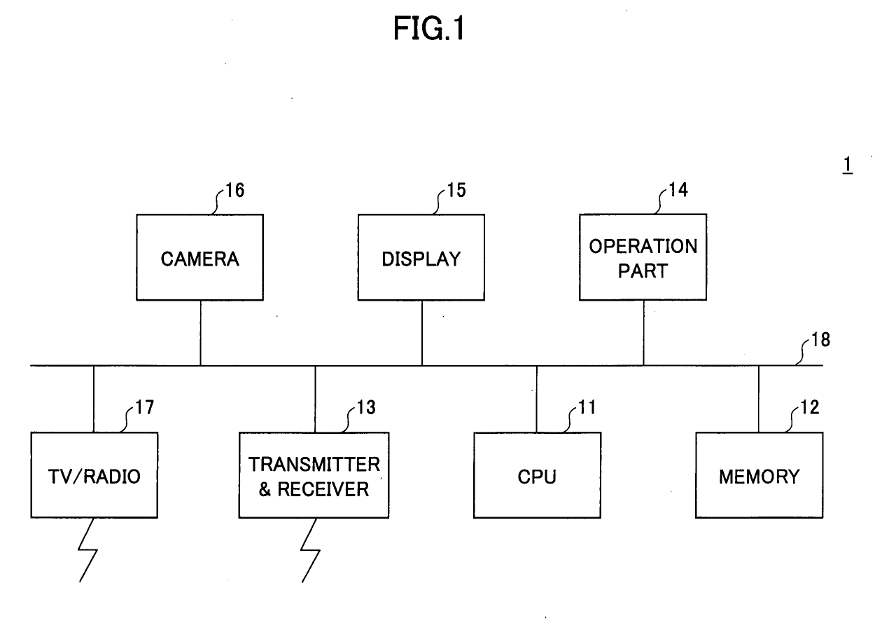

FIG. 1 is a system block diagram showing a structure of an important part of this embodiment of the electronic apparatus according to the present invention. In this embodiment, the present invention is applied to a portable telephone set for the sake of convenience, but the electronic apparatus according to the present invention is of course not limited to the portable telephone set. The electronic apparatus includes various apparatuses having a plurality of functions, such as computers, personal digital assistants (PDAs) and communication apparatuses. The electronic apparatus may be a set-up type apparatus such as a desk-top computer or, a portable type apparatus such as a portable computer.

This embodiment of the electronic apparatus employs an embodiment of the key lock control method according to the present invention and an embodiment of a computer-readable storage medium according to the present invention.

A portable telephone set 1 shown in FIG. 1 includes a CPU 11, a memory part 12, a transmitter and receiver part 13, an operation part 14 including a plurality of operation keys, a display part 15, a camera part 16 and a television (TV) and/or radio part 17 which are connected via a bus 18. The CPU 11 controls the general operation of the entire portable telephone set 1. The memory part 12 may be formed by a semiconductor memory device. The memory part 12 stores computer programs to be executed by the CPU 11, and various data including intermediate data of operations carried out by the CPU 11 and operation patterns of the operation keys which will be described later. The transmitter and receiver part 13 has a known structure for making transmissions and receptions via an antenna (not shown).

The operation part 14 has the plurality of operation keys that are operated (or manipulated) when the user inputs information to the portable telephone set 1. For example, the operation keys include numeric and/or character input keys (or alphanumeric keys), cursor moving keys, a determination key and the like. The display part 15 displays various menus which will be described later, information input from the operation keys, and the like. The operation part 14 and the display part 15 may be provided integrally as in the case of a touch panel. The camera part 16 has a known structure capable of picking up an object image. The TV and/or radio part 17 has a known structure capable of receiving a TV broadcast and/or a radio broadcast via an antenna (not shown).

In this embodiment, the electronic apparatus makes a wireless communication. However, in a case where the electronic apparatus makes a cable communication, a transmitter and receiver part including an interface for connecting to a network may be provided in place of the transmitter and receiver part 13.

The computer programs stored in the memory part 12 include a key lock control program for carrying out a key lock control. In this embodiment, a computer-readable storage medium which stores the key lock control program is the semiconductor memory device forming the memory part 12. However, a storage medium forming the computer-readable storage medium is not limited to a particular type, and may be formed by any type of storage media capable of storing the key lock control program in a computer-readable manner. For example, the computer-readable storage medium may be formed by magnetic recording media, optical recording media and magneto-optic storage media.

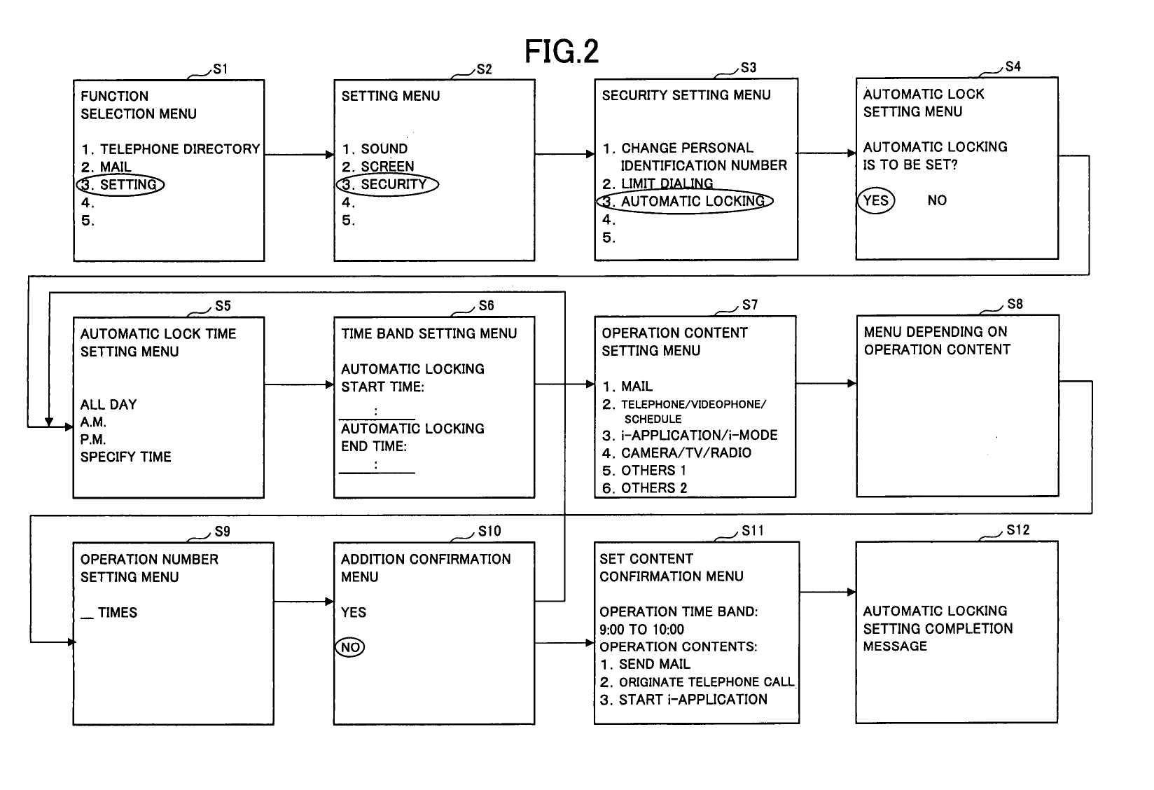

FIG. 2 is a flow chart for explaining an operation pattern registration process of this embodiment. The operation pattern registration process shown in FIG. 2 is carried out by the CPU 11. For the sake of convenience, FIG. 2 shows menus and information that are displayed on the display part 15 in various steps.

In FIG. 2, when a predetermined key of the operation part 14 is operated to instruct a function selection, a step S1 displays a function selection menu on the display part 15. When the cursor moving key and the determination key of the operation part 14 are operated to select a setting function on the function selection menu, a step S2 displays a setting menu on the display part 15. When the corresponding numeric and/or character key or the cursor moving key and the determination key of the operation part 14 are operated to select a security function on the setting menu, a step S3 displays a security setting menu on the display part 15. For example, when the corresponding numeric and/or character key or the cursor moving key and the determination key of the operation part 14 are operated to select an automatic locking function on the security setting menu, a step S4 displays an automatic lock setting menu on the display part 15.

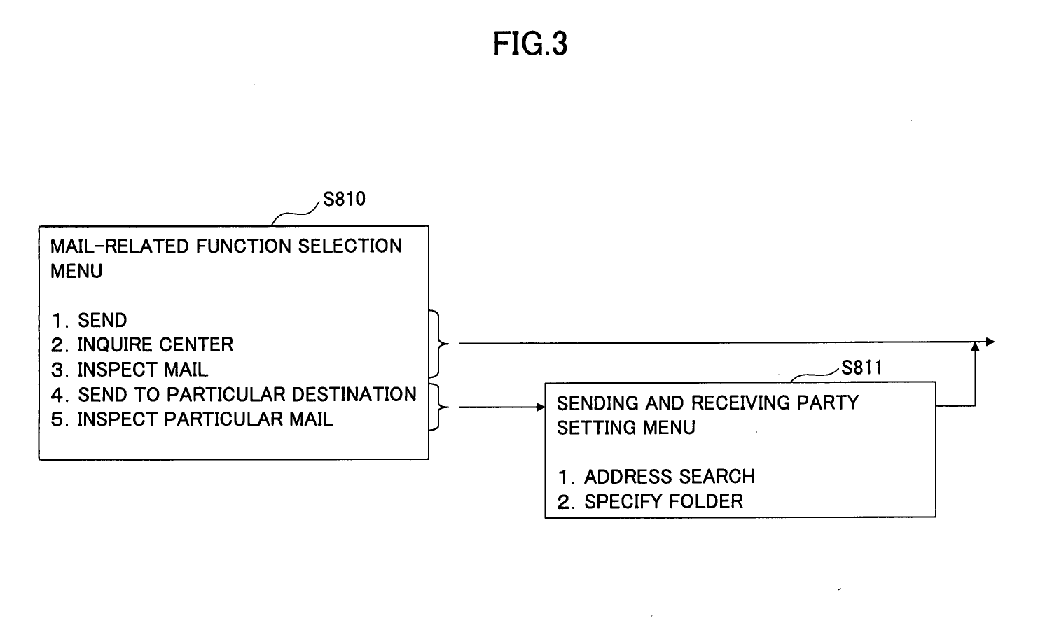

For example, when the cursor moving key and the determination key of the operation part 14 are operated to select “YES” on the automatic lock setting menu so as to select the automatic locking function, a step S5 displays an automatic lock time setting menu on the display part 15. For example, “all day”, “A.M.”, “P.M.” or “specify time” are selectable on the automatic lock time setting menu. For example, when the “specify time” is selected on the automatic lock time setting menu, a step S6 displays on the display part 15 a time band setting menu which urges the user to input an automatic locking start time and an automatic locking end time. When the automatic locking start time and the automatic locking end time are input by the key operation of the operation part 14, a step S7 displays an operation content setting menu on the display part 15. In this embodiment, the operation content is selectable from “electronic mail (e-mail)”, “telephone/videophone/schedule”, “i-application/i-mode”, “camera/TV/radio”, “others 1” and “others 2”. A step S8 displays on the display part 15 a menu depending on the selected operation content. More particularly, the step S8 displays a corresponding one of the menus shown in FIGS. 3 through 8 depending on the selected operation content. FIGS. 3 through 8 are flow charts for explaining a part of the operation pattern registration process.

When the “e-mail” is selected on the operation content setting menu by the key operation of the operation part 14, a step S810 shown in FIG. 3 displays an e-mail-related function selection menu on the display part 15. In this embodiment, the e-mail-related function (or operation) is selectable from “send (or outbox)”, “inquire center (or check new message)”, “inspect e-mail”, “send to particular destination” and “inspect particular e-mail”. When the “send”, “inquire center” or “inspect e-mail” is selected on the e-mail-related function selection menu by the key operation of the operation part 14, the process advances to a step S9 shown in FIG. 2. On the other hand, when the “send to particular destination” or “inspect particular e-mail” is selected on the e-mail-related function selection menu by the key operation of the operation part 14, a step S811 displays a sending and receiving party setting menu on the display part 15. “Address search” and “specify folder” are selectable on the sending and receiving party setting menu. When the “address search” or “specify folder” is selected on the sending and receiving party setting menu by the key operation of the operation part 14, the process advances to the step S9 shown in FIG. 2.

In FIG. 2, the step S9 displays a operation number setting menu on the display part 15. An operation number, that is, the number times an operation of the set operation content is to be carried out, can be set on the operation number setting menu. When the operation number is set on the operation number setting menu by the key operation of the operation part 14, a step S10 displays an addition confirmation menu on the display part 15. If an operation content needs to be added on the addition confirmation menu, “YES” is selected on the addition confirmation menu, and the process returns to the step S5. Accordingly, the automatic locking start time and the automatic locking end time, that is, the operation time band, can be set independently for each set operation content (function). In addition, the operation number of the operation content can also be set independently for each set operation content. On the other hand, if it is unnecessary to add an operation content on the addition confirmation menu, “NO” is selected on the addition conformation menu, and the process advances to a step S11.

The step S11 displays a set content confirmation menu on the display part 15. The operation pattern that is set by the operation described above, that is, the operation time band and the operation content are displayed on the set content confirmation menu. FIG. 2 shows a case where “9:00 to 10:00” is set as the operation time band, and “send mail”, “originate telephone call” and “start i-application” are set as the operation content. After displaying the set content confirmation menu, a step S12 displays an automatic locking setting completion message on the display part 15, and the operation pattern registration process ends.

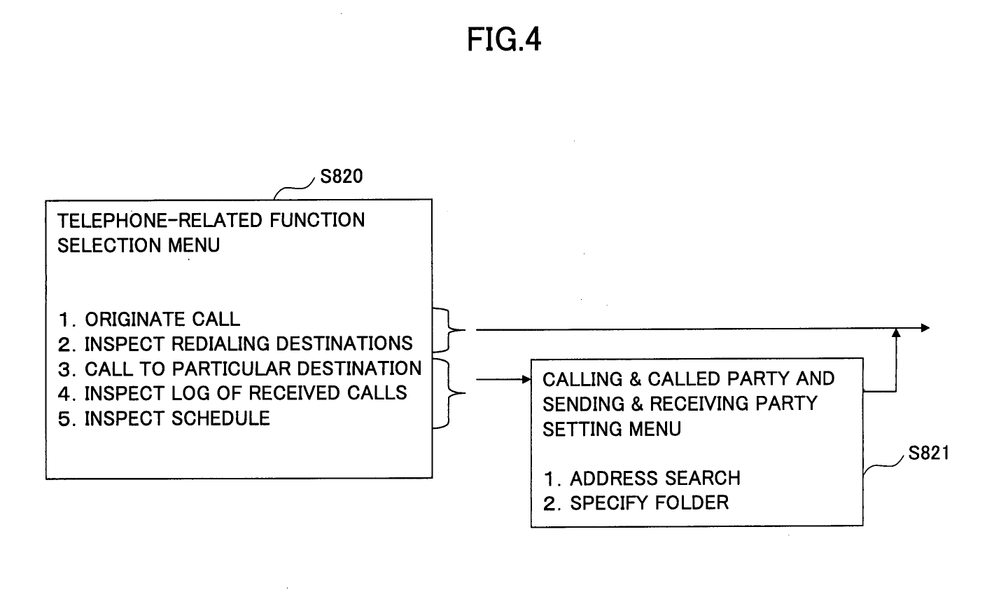

When the “telephone/videophone/schedule” is selected on the operation content setting menu by the key operation of the operation part 14, a step S820 shown in FIG. 4 displays a telephone-related function (or communication operation) selection menu on the display part 15. In this embodiment, the telephone-related function (or operation) is selectable from “originate call”, “inspect redialing destinations”, “call to particular destination”, “inspect log of received calls” and “inspect schedule”. When the “originate call” or “inspect redialing destinations” is selected on the telephone-related function selection menu by the key operation of the operation part 14, the process advances to the step S9 shown in FIG. 2. On the other hand, when the “call to particular destination”, “inspect log of received calls” or “inspect schedule” is selected on the telephone-related function selection menu by the key operation of the operation part 14, a step S821 displays a calling and called party and sending and receiving party setting menu on the display part 15. “Address search” and “specify folder” are selectable on the calling and called party and sending and receiving party setting menu. When the “address search” or “specify folder” is selected on the calling and called party and sending and receiving party setting menu by the key operation of the operation part 14, the process advances to the step S9 shown in FIG. 2.

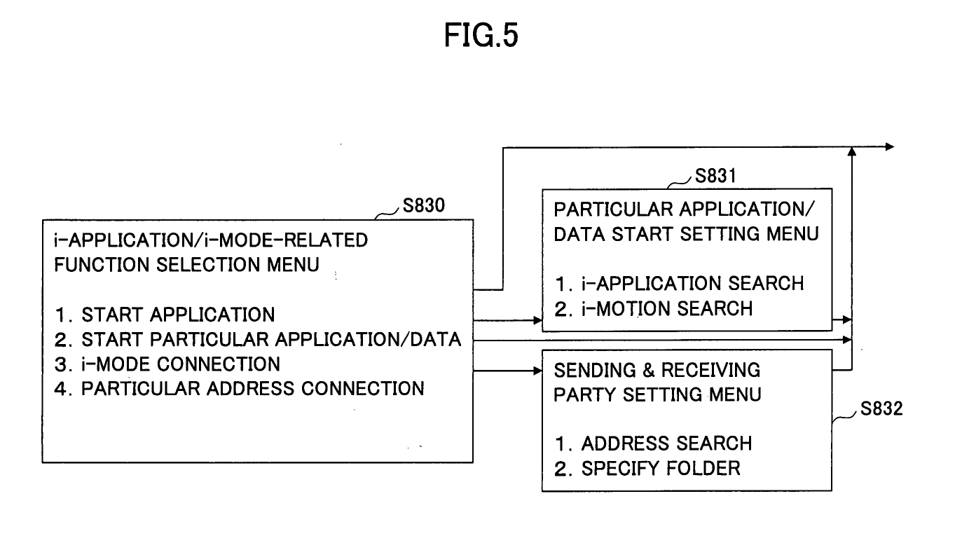

When the “i-application/i-mode (Internet-related operation)” is selected on the operation content setting menu by the key operation of the operation part 14, a step S830 shown in FIG. 5 displays an i-application/i-mode-related function selection menu on the display part 15. In this embodiment, the i-application/i-mode-related function (or operation) is selectable from “start application”, “start particular application/data”, “i-mode connection” and “particular address connection”. When the “start application” or “i-mode connection” is selected on the i-application/i-mode-related function selection menu by the key operation of the operation part 14, the process advances to the step S9 shown in FIG. 2. On the other hand, when the “particular application/data start” is selected on the i-application/i-mode-related function selection menu by the key operation of the operation part 14, a step S831 displays a particular application/data start setting menu on the display part 15. In this embodiment, “i-application search” and “i-motion search” are selectable on the particular application/data start setting menu. When the “i-application search” or “i-motion search” is selected on the particular application/data start setting menu by the key operation of the operation part 14, the process advances to the step S9 shown in FIG. 2. In addition, when the “particular address connection” is selected on the i-application/i-mode-related function selection menu by the key operation of the operation part 14, a step S832 displays a sending and receiving party setting menu on the display part 15. In this embodiment, “address search” and “specify folder” are selectable on the sending and receiving party setting menu. When the “address search” or “specify folder” is selected on the sending and receiving party setting menu by the key operation of the operation part 14, the process advances to the step S9 shown in FIG. 2.

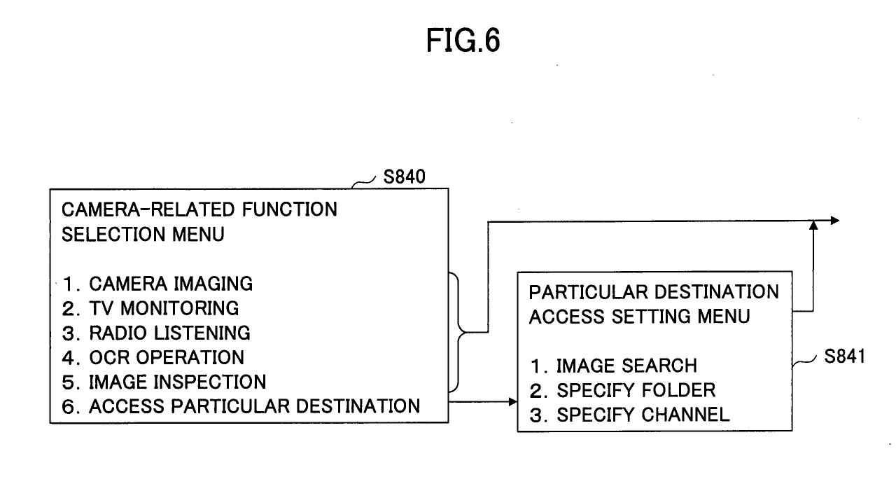

When the “camera/TV/radio” is selected on the operation content setting menu by the key operation of the operation part 14, a step S840 shown in FIG. 6 displays a camera-related function (or image pickup function) selection menu on the display part 15. In this embodiment, the camera-related function (or operation) is selectable from “camera imaging”, “TV monitoring”, “radio listening”, “OCR operation”, “image inspection” and “access particular destination”. When the “camera imaging”, “TV monitoring”, “radio listening”, “OCR operation” or “image inspection” is selected on the camera-related function selection menu by the key operation of the operation part 14, the process advances to the step S9 shown in FIG. 2. On the other hand, when the “access particular destination” is selected on the camera-related function selection menu by the key operation of the operation part 14, a step S841 displays a particular destination access setting menu on the display part 15. In this embodiment, “image search”, “specify folder” and “specify channel” are selectable on the particular destination access setting menu. When the “image search”, “specify folder” or “specify channel” is selected on the particular destination access setting menu by the key operation of the operation part 14, the process advances to the step S9 shown in FIG. 2.

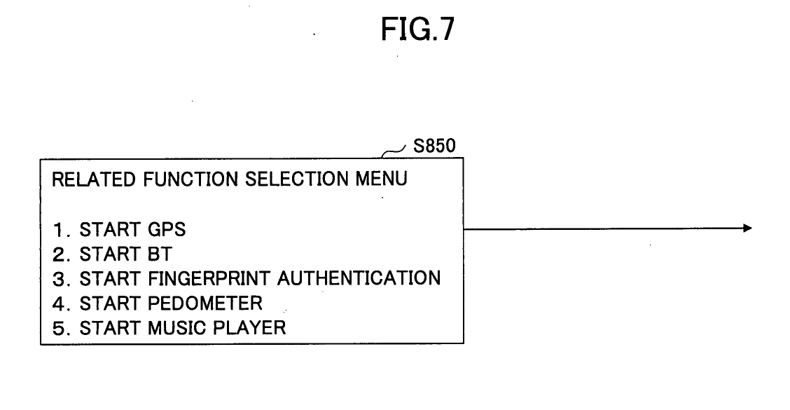

When the “others 1” is selected on the operation content setting menu by the key operation of the operation part 14, a step S850 shown in FIG. 7 displays a related function selection menu on the display part 15. In this embodiment, “start ground positioning system (GPS)”, “start blue tooth (BT)”, “start fingerprint authentication”, “start pedometer” and “start music player” are selectable on the related function (or operation) selection menu. When the “start GPS”, “start BT”, “start fingerprint authentication”, “start pedometer” or “start music player” is selected on the related function selection menu by the key operation of the operation part 14, the process advances to the step S9 shown in FIG. 2.

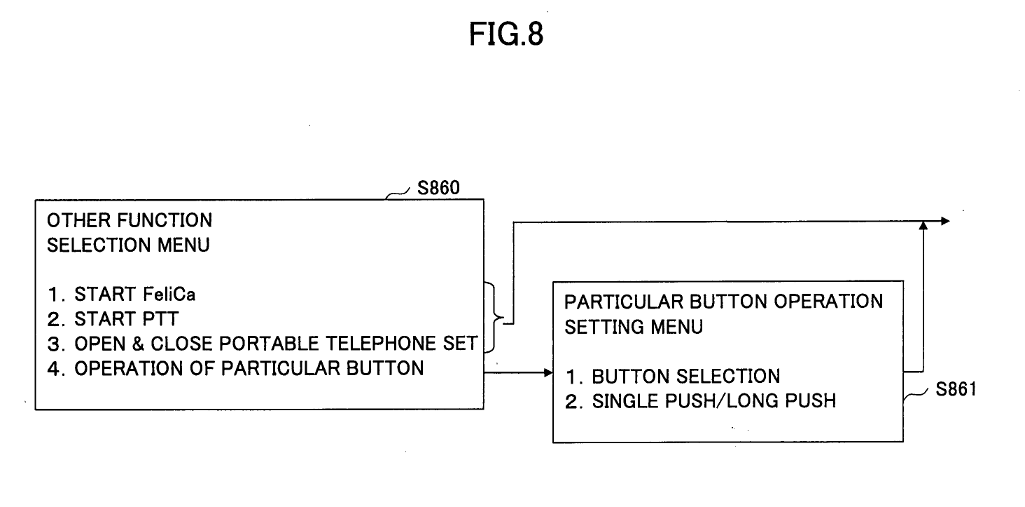

When the “others 2” is selected on the operation content setting menu by the key operation of the operation part 14, a step S860 shown in FIG. 8 displays an other function selection menu on the display part 15. In this embodiment, “start FeliCa”, “start push-to-talk (PTT)”, “open and close portable telephone set” and “operation of particular button (or key)” are selectable on the other function (or operation) selection menu. The “open and close portable telephone set” refers to the opening and closing, sliding or rotating (or turning) of a lid of a folding type portable telephone set. When the “start FeliCa”, “start PTT” or “open and close portable telephone set” is selected on the other function selection menu by the key operation of the operation part 14, the process advances to the step S9 shown in FIG. 2. On the other hand, when the “operation of particular button” is selected on the other function selection menu by the key operation of the operation part 14, a step S861 displays a particular button operation setting menu on the display part 15. In this embodiment, “button selection” and “single push/long push” are selectable on the particular button operation setting menu. When the “button selection” or “single push/long push” is selected on the particular button operation setting menu by the key operation of the operation part 14, the process advances to the step S9 shown in FIG. 2.

The operation time band and the operation contents (functions) that are set in the above described manner, that is, the operation pattern, is stored and registered in the memory part 12. The operation contents that are set in the steps S7 and S8 shown in FIG. 2 may include details of the operation contents (functions) that are set by the steps S811, S821, S831, S832, S841 and S861 shown in FIGS. 3 through 8.

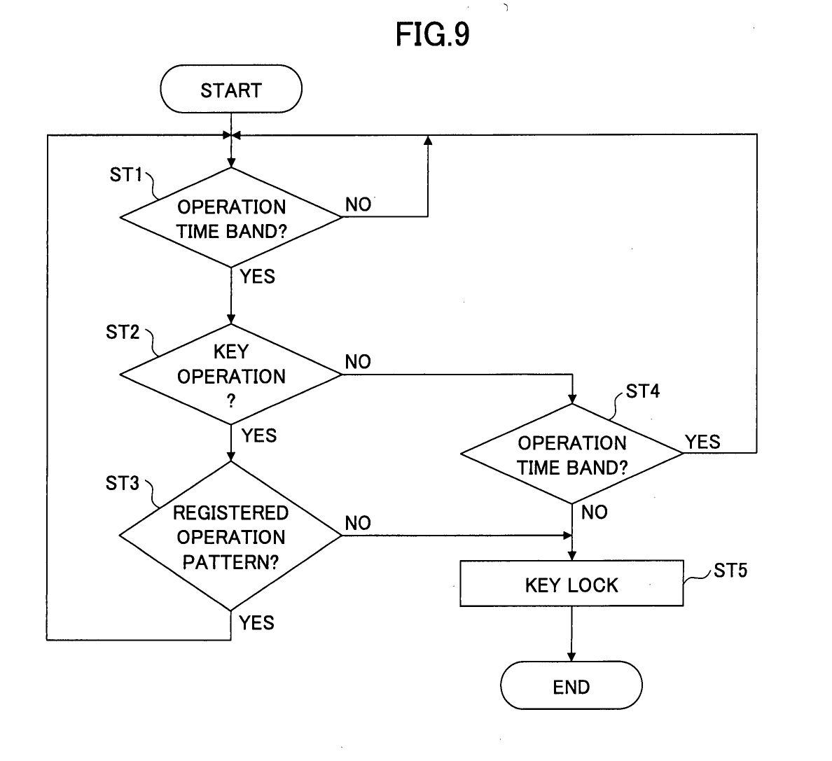

FIG. 9 is a flow chart for explaining a key lock process of this embodiment. The key lock process shown in FIG. 9 is carried out by the CPU 11. In FIG. 9, a step ST1 decides whether or not a present time falls within the operation time band that is included in the operation pattern registered in the memory part 12, and the process advances to a step ST2 if the decision result in the step ST1 becomes YES. The step ST2 decides whether or not one or more operation keys of the operation part 14 has been operated (or manipulated), and the process advances to a step ST3 if the decision result in the step ST2 becomes YES. The step ST3 decides whether or not the operated operation keys indicate all of the operation contents with respect to the operation time band included in the registered operation pattern, and the process returns to the step ST1 if the decision result in the step ST3 is YES. As described above, the operation contents may include, in addition to each function, that is set the operation number of each function that is set and/or the details of each function that is set.

For example, in a case where the registered operation pattern includes N operation contents with respect to one operation time band, where N is an integer greater than or equal to 2, the step ST3 may decide whether or not the operated operation keys indicate at least M operation contents, where M is an integer satisfying M<N.

On the other hand, if the decision result in the step ST2 is NO, a step ST4 decides whether or not the present time falls within the operation time band that is included in the registered operation pattern, and the process returns to the step ST1 if the decision result in the step ST4 is YES. If the present time exceeds the operation time band and the decision result in the step ST4 is NO, a step ST5 locks the operation keys of the operation part 14 by a known means so that a normal operation of the operation keys becomes impossible, and the key lock process ends. In addition, if the decision result in the step ST3 is NO, there is a possibility that an unauthorized use of the portable telephone set 1 is being made, and thus, the step ST5 locks the operation keys of the operation part 14, and the key lock process ends.

The operation keys in the locked state may be unlocked (or released) by a known method. Since the unlocking of the locked operation keys or canceling the locking with respect to the operation keys is not directly related to the subject matter of the present invention, a description of the unlocking or canceling mechanism and process will be omitted.

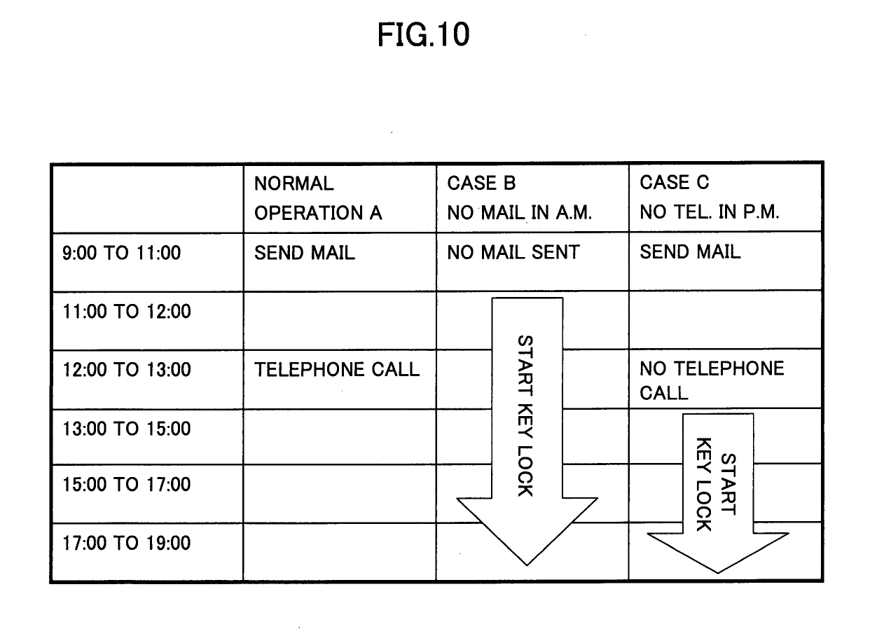

FIG. 10 is a diagram for explaining the key lock process of this embodiment. FIG. 10 shows a case where the registered operation pattern includes the sending of the mail within the time band from 9:00 to 11:00 and the telephone call within the time band from 12:00 to 13:00. For a normal operation A, the user operates the portable telephone set 1 with the registered operation pattern. In other words, for the normal operation A, the user sends a mail within the time band from 9:00 to 11:00 and makes a telephone call within the time band from 12:00 to 13:00, and thus, the operation keys of the operation part 14 are not locked.

However, in a case B where no mail is sent within the time band from 9:00 to 11:00, the operation keys of the operation part 14 are locked automatically. Similarly, even if a mail is sent within the time band from 9:00 to 11:00, if no telephone call is made within the time band from 12:00 to 13:00 as in a case C, the operation keys of the operation part 14 are locked automatically. Hence, the operation keys of the operation part 14 are locked automatically unless the operation keys are operated with the registered operation pattern, without requiring the user to be particularly aware of when to lock and when not to lock the operation keys. In addition, since the operation keys of the operation part 14 will not be locked unnecessarily as long as the operation keys are operated with the registered operation pattern, the user does not need to frequently carry out the troublesome and complicated operation of canceling the locking with respect to the locked operation keys or unlocking the locked operation keys.

Moreover, in a case where the manner in which the user uses the portable telephone set 1 is relatively regular, it is possible to set the time band and the operation contents of the operation pattern that is to be registered in more detail, so as to further improve the security.

Further, the present invention is not limited to these embodiments, but various variations and modifications may be made without departing from the scope of the present invention.

What is claimed is:

1. A key lock control method comprising:
registering an operation pattern of operation keys of an electronic apparatus which has a plurality of functions; and
locking the operation keys if the operation keys are not operated according to the operation pattern,
said operation pattern comprising a combination of at least a time band in which one or more operation keys are to be operated and at least one function that is to be selected by one or more operation keys.

2. The key lock control method as claimed in claim 1, wherein said at least one function is selected from a group consisting of electronic mail, telephone call, schedule, Internet-related operation, imaging, television, radio and other operations.

3. The key lock control method as claimed in claim 1, wherein said operation pattern includes a number of times each function is selected.

4. The key lock control method as claimed in claim 1, wherein said operation pattern includes details of each function selected by one or more operation keys.

5. The key lock control method as claimed in claim 1, wherein said time band is set independently with respect to two or more functions that are selected.

6. An electronic apparatus having a plurality of functions, comprising:
a plurality of operation keys;
a memory part configured to register an operation pattern of the operation keys based on inputs from the operation keys; and
a control part configured to lock the operation keys if the operation keys are not operated according to the operation pattern,
said operation pattern comprising a combination of at least a time band in which one or more operation keys are to be operated and at least one function that is to be selected by one or more operation keys.

7. The electronic apparatus as claimed in claim 6, wherein said at least one function is selected from a group consisting of electronic mail, telephone call, schedule, Internet-related operation, imaging, television, radio and other operations.

8. The electronic apparatus as claimed in claim 6, wherein said operation pattern includes a number of times each function is selected.

9. The electronic apparatus as claimed in claim 6, wherein said operation pattern includes details of each function selected by one or more operation keys.

10. The electronic apparatus as claimed in claim 6, wherein said time band is set independently with respect to two or more functions that are selected.

11. A computer-readable storage medium which stores a program for causing a computer to lock operation keys of an apparatus having a plurality of functions, said program comprising:
a procedure causing the computer to register an operation pattern of the operation keys; and
a procedure causing the computer to lock the operation keys if the operation keys are not operated according to the operation pattern,
said operation pattern comprising a combination of at least a time band in which one or more operation keys are to be operated and at least one function that is to be selected by one or more operation keys.

12. The computer-readable storage medium as claimed in claim 11, wherein said at least one function is selected from a group consisting of electronic mail, telephone call, schedule, Internet-related operation, imaging, television, radio and other operations.

13. The computer-readable storage medium as claimed in claim 11, wherein said operation pattern includes a number of times each function is selected.

14. The computer-readable storage medium as claimed in claim 11, wherein said operation pattern includes details of each function selected by one or more operation keys.

15. The computer-readable storage medium as claimed in claim 11, wherein said time band is set independently with respect to two or more functions that are selected.

16. The computer-readable storage medium as claimed in claim 11, wherein the computer is provided within the apparatus which is selected from a group consisting of computers, personal digital assistants (PDAs) and communication apparatuses.

17. A computer program for causing a computer to lock operation keys of an apparatus having a plurality of functions, comprising:
causing the computer to register an operation pattern of the operation keys; and
causing the computer to lock the operation keys if the operation keys are not operated according to the operation pattern,
said operation pattern comprising a combination of at least a time band in which one or more operation keys are to be operated and at least one function that is to be selected by one or more operation keys.
